(19) United States
(12) Patent Application Publication
(10) Pub. No.: US 2010/0155435 A1
(43) Pub. Date: Jun. 24, 2010

(54) NOZZLE SUBSTRATE, DROPLET DISCHARGE HEAD, AND METHOD FOR MANUFACTURING NOZZLE SUBSTRATE

(75) Inventor: Seiji YAMAZAKI, Fujimi-machi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Tokyo (JP)

(21) Appl. No.: 12/629,403

(22) Filed: Dec. 2, 2009

(30) Foreign Application Priority Data
Dec. 18, 2008 (JP) 2008-322210

(51) Int. Cl. B67D 7/06; B23P 17/04

(52) U.S. Cl. 222/566; 29/592

(57) ABSTRACT

A nozzle substrate having a nozzle hole for discharging droplets includes a first substrate layer and a second substrate layer. The first substrate layer is disposed on a fluid discharge side of the nozzle substrate. The first substrate layer is made of silicon material. The second substrate layer is disposed on a fluid introduction side of the nozzle substrate. The second substrate layer is made of borosilicate glass material

### CROSS-REFERENCE TO RELATED APPLICATIONS

This application claims priority to Japanese Patent Application No. 2008-322210 filed on Dec. 18, 2008. The entire disclosure of Japanese Patent Application No. 2008-322210 is hereby incorporated herein by reference.

### BACKGROUND

1. Technical Field

The present invention relates to a nozzle substrate, a droplet discharge head, and a method for manufacturing a nozzle substrate.

2. Related Art

A recent trend is seen in the use of droplet discharge heads not only for ink, but also for color filters, organic EL, and other industrial applications, as well as bio-molecular applications and other bio-related applications. A droplet discharge head has a layered structure made of nozzle substrate, a cavity substrate, and the like, and the substrates are bonded together using various bonding methods. However, in the case that an adhesive is used for bonding the substrates, the adhesive is liable to be melted by the fluid for an industrial application or the fluid for a bio-related application.

The nozzle substrate of a conventional droplet discharge head is formed from a glass material and is bonded by anodic bonding to a silicon cavity substrate without the use of an adhesive (e.g., see Japanese Laid-Open Patent Application No. 2005-161706, page 5, FIG. 2).

### SUMMARY

In accordance with the technique described in the above mentioned reference, it is not necessarily easy to form a very small nozzle hole with high precision by laser machining or dry etching because the nozzle substrate is formed using a glass material.

The present invention was contrived in order to solve the problems described above, and an object thereof is to provide a nozzle substrate that is highly compatible with a fluid and has a very small, highly precise nozzle hole, and to provide a droplet discharge head and a method for manufacturing a nozzle substrate.

A nozzle substrate according to a first aspect of the present invention has a nozzle hole for discharging droplets. The nozzle substrate includes a first substrate layer disposed on a fluid discharge side of the nozzle substrate, the first substrate layer being made of silicon material, and a second substrate layer disposed on a fluid introduction side of the nozzle substrate, the second substrate layer being made of borosilicate glass material.

Since the nozzle part on the fluid discharge side and the fluid introduction side are each formed on the first and second substrate layers, a very small and highly precise nozzle hole can be formed in a simple manner. Also, machinability is excellent because one of the base elements is made of silicon material.

In the nozzle substrate according to a second aspect of the present invention, the first substrate layer and the second substrate layer are preferably anodically bonded.

In the nozzle substrate, the first substrate layer made of silicon material, and the second substrate layer made of borosilicate glass silicon material are anodically bonded, and since an adhesive is not used, compatibility with a fluid is excellent.

In the nozzle substrate according to a third aspect of the present invention, the first substrate layer preferably includes a fluid discharge nozzle part of the nozzle hole, and the second substrate layer preferably includes a fluid introduction nozzle part of the nozzle hole with the fluid introduction nozzle part having a larger diameter than the fluid discharge nozzle part and being coaxial to the fluid discharge nozzle part.

The nozzle parts are formed and coaxially arranged in the first and second substrate layers, making it possible to form a nozzle hole having a small diameter in the discharge side and a large diameter in the introduction side.

A droplet discharge head according to a fourth aspect of the present invention includes the nozzle substrate described above, a cavity substrate and an electrode substrate. The cavity substrate has a discharge chamber and a reservoir recess portion. The discharge chamber fluidly communicates with the nozzle hole with a vibration plate being formed in a portion of a wall surface of the discharge chamber. The reservoir recess portion is arranged to feed fluid to the discharge chamber. The electrode substrate has an individual electrode disposed to face the vibration plate so that the vibration plate is displaced by electrostatic force between the vibration plate and the individual electrode to discharge fluid in the discharge chamber from the nozzle hole. The cavity substrate and the nozzle substrate are anodically bonded. The cavity substrate and the electrode substrate are anodically bonded.

The first and second substrate layers of the nozzle substrate and the cavity substrate and the electrode substrate of the droplet discharge head are anodically bonded to each other, and an adhesive is not used for bonding. Therefore, compatibility with fluid is excellent, the structure can withstand long-term driving, and precision and reliability are high.

In the droplet discharge head according to a fifth aspect of the present invention, the cavity substrate is made of silicon material and the electrode substrate is preferably made of borosilicate glass substrate, the first and second substrate layers of the nozzle substrate are preferably anodically bonded, and the second substrate layer of the nozzle substrate and the cavity substrate are preferably anodically bonded.

The first and second substrate layers and the cavity substrate and the electrode substrate of the droplet discharge head are anodically bonded to each other, and an adhesive is not used for bonding. Therefore, compatibility with fluid is excellent, the structure can withstand long-term driving, and precision and reliability are high. Accordingly, wide application can be made not only to ink, but also to color filters, organic EL, and other industrial applications, as well as bio-molecular applications and other bio-related applications.

In the droplet discharge head according to a sixth aspect of the present invention, a bottom part of the reservoir recess portion of the cavity substrate is preferably disposed closer to the nozzle substrate than a bottom part of the discharge chamber to form a diaphragm.

The pressure interference mechanism is provided and the discharge characteristics can be stabilized because the diaphragm is formed on the bottom part of the reservoir recess portion.

In the droplet discharge head according to a seventh aspect of the present invention, the bottom part of the reservoir recess portion preferably includes a bottom wall having a boron-doped layer to form a pressure interference diaphragm.

Variability in channel resistance can be reduced because the depth of the reservoir is controlled with high precision using a thin boron-doped layer formed on the bottom part of the reservoir recess portion.

In the droplet discharge head according to an eighth aspect of the present invention, the second substrate layer of the nozzle substrate preferably includes a second reservoir recess portion fluidly communicating with the reservoir recess portion of the cavity substrate so that the second reservoir recess portion and the reservoir recess portion form a reservoir.

The volume of the reservoir can be increased because a reservoir is formed by the reservoir recess portion and the second reservoir recess portion.

In the droplet discharge head according to a ninth aspect of the present invention, the electrode substrate preferably includes a first fluid feedhole part, the cavity substrate preferably includes a second fluid feedhole part fluidly communicating with the first fluid feedhole part to form a fluid feedhole adjacent to the reservoir with the fluid feedhole penetrating through the electrode substrate and the cavity substrate in a laminating direction of the electrode substrate and the cavity substrate, the second fluid feedhole part preferably has a droplet feed groove that widens at a downstream side of the second fluid feedhole part so that fluid fed from the fluid feedhole is transferred from the fluid feed groove to the reservoir recess portion via the second reservoir recess portion.

Since a reservoir is formed by the reservoir recess portion and the second reservoir recess portion, the volume of the reservoir can be increased and channel resistance of the reservoir can thereby be reduced.

A method for manufacturing a nozzle substrate according to a tenth aspect of the present invention includes forming a fluid discharge nozzle part in a first substrate layer made of silicon material, anodically bonding a second substrate layer made of borosilicate glass material to the first substrate layer, and forming a fluid introduction nozzle part in the second substrate layer coaxially to the fluid discharge nozzle part so that the fluid discharge nozzle part and the fluid introduction nozzle part form a nozzle hole.

Since the first and second substrate layers are bonded by anodic bonding, compatibility with fluids is excellent, and a very small, highly precise nozzle hole can be formed in a simple manner.

### BRIEF DESCRIPTION OF THE DRAWINGS

Referring now to the attached drawings which form a part of this original disclosure:

FIG. 1 is an exploded perspective view of the droplet discharge head of a illustrated embodiment of the present invention;

FIG. 2 is a longitudinal sectional view of the assembled state of the droplet discharge head of FIG. 1;

FIG. 3 is a series of cross-sectional views showing the steps for manufacturing a cavity substrate of the droplet discharge head according to the illustrated embodiment;

FIG. 4 is a series of cross-sectional views showing the steps for manufacturing a cavity substrate of the droplet discharge head continuing from FIG. 3;

FIG. 5 is a series of cross-sectional views showing the steps for manufacturing a cavity substrate of the droplet discharge head continuing from FIG. 4;

FIG. 6 is a series of cross-sectional views showing the steps for manufacturing a nozzle substrate of the droplet discharge head according to the illustrated embodiment;

FIG. 7 is a series of cross-sectional views showing the steps for manufacturing a nozzle substrate of the droplet discharge head continuing from FIG. 6;

FIG. 8 is a series of cross-sectional views showing the steps for manufacturing a nozzle substrate of the droplet discharge head continuing from FIG. 7;

FIG. 9 is a series of cross-sectional views showing the steps for manufacturing a nozzle substrate of the droplet discharge head continuing from FIG. 8;

FIG. 10 is a series of cross-sectional views showing the steps for manufacturing a nozzle substrate of the droplet discharge head continuing from FIG. 9;

FIG. 11 is a series of cross-sectional views showing the steps for manufacturing the droplet discharge head according to the illustrated embodiment;

FIG. 12 is a series of cross-sectional views showing the steps for manufacturing the droplet discharge head continuing from FIG. 11;

FIG. 13 is a series of cross-sectional views showing the steps for manufacturing the droplet discharge head continuing from FIG. 12;

FIG. 14 is a series of cross-sectional views showing the steps for manufacturing the droplet discharge head continuing from FIG. 13; and

FIG. 15 is a perspective view of the droplet discharge head according to the illustrated embodiment of the present invention.

### DETAILED DESCRIPTION OF EXEMPLARY EMBODIMENTS

### Droplet Discharge Head

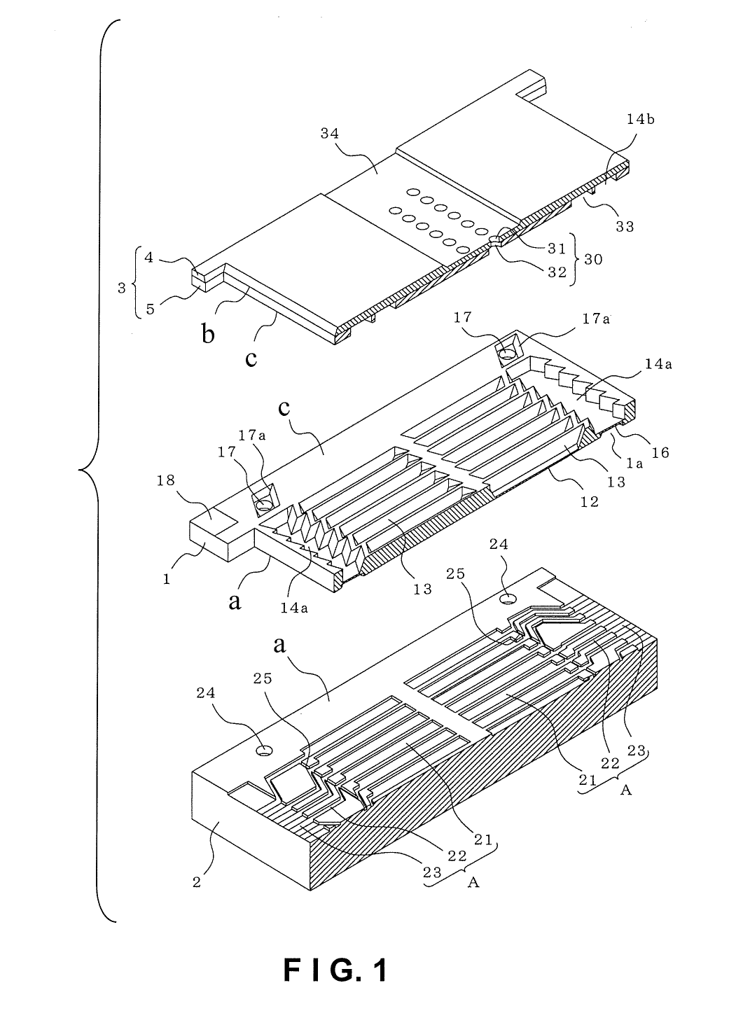

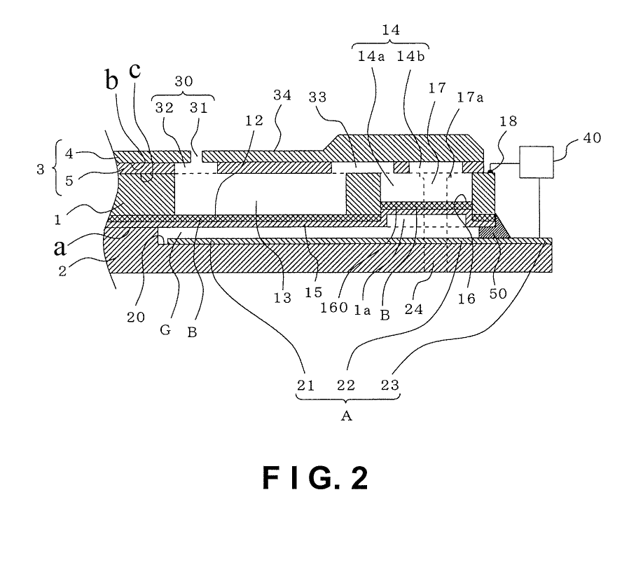

FIG. 1 is an exploded perspective view of the droplet discharge head of the illustrated embodiment of the present invention, and FIG. 2 is a longitudinal sectional view of the assembled state of the droplet discharge head of FIG. 1. The illustrated embodiment relates to a face-type droplet discharge head for discharging droplets from a nozzle holes provided in the face part of a substrate.

The droplet discharge head includes a tri-layered structure in which a cavity substrate 1 having a vibration plate, an electrode substrate 2 having an electrode part, and a nozzle substrate 3 having a nozzle hole are layered, as shown in FIGS. 1 and 2.

The cavity substrate 1 intermediately positioned in the tri-layer structure is a silicon (Si) single crystal substrate (hereinafter also referred to as silicon substrate) having a thickness of, e.g., about 50 μm and a (110) orientation. The cavity substrate 1 is formed by anisotropic wet etching on a silicon substrate, and has discharge chambers 13 in which the bottom wall is a vibration plate 12, and also has a reservoir recess portion 14a (reservoir 14) which is shared among the nozzle holes (described later) and in which a fluid to be discharged is stored.

The vibration plate 12 has a thickness of about 0.8 μm and is formed using a high-density boron-doped layer B having the same thickness. In the case that the silicon substrate has been subjected to anisotropic wet etching using an alkaline aqueous solution, the etching rate is dramatically reduced in the high-density region (about 5×10¹⁹ atoms·cm⁻³ or more) when boron is used as the dopant. Therefore, the thickness of the vibration plate 12 and the volume of the discharge chambers 13 can be selected with good precision using a so-called etching stop technique that involves anisotropic wet etching.

The reservoir recess portion 14a (reservoir 14) is formed using a boron-etching stop technique, a groove 1a is provided to the reverse side of the bottom part, and a diaphragm 16 that is suspended above the electrode substrate 2 and has a pressure-alleviating function is constructed. A bottom wall 160 of the diaphragm 16 is formed by the thin boron-doped layer B.

A fluid feedhole (second fluid feedhole part) 17 is provided in the cavity substrate 1, is formed completely through the outer-side substrate of the reservoir 14 in the vertical direction (i.e., the laminating direction of the substrates), widens in the downstream side (upper side of FIG. 1), and forms a fluid feed groove 17a.

A TEOS (tetraethyl orthosilicate, tetraethoxysilane, ethyl silicate) film that serves as an insulating film 15 is formed by plasma CVD (chemical vapor deposition) to a thickness of, e.g., 0.1 μm on the lower surface of the cavity substrate 1. The purpose for this is to prevent breakage of the insulating film and short-circuiting when the droplet discharge head is driven.

A terminal part 18 of a shared electrode is formed on the cavity substrate 1.

The electrode substrate 2 is arranged on the lower side (lower side of FIG. 1) of the cavity substrate 1 and is bonded to the cavity substrate 1 by anodic bonding (bonding surface a). The electrode substrate 2 is made of heat-resistant hard borosilicate glass having a thickness of about 1 mm. An electrode concavity 20 having a depth of about 0.2 μm is provided to the electrode substrate 2 by etching in conformity with each of the discharge chambers 13 formed in the cavity substrate 1, and individual electrodes 21, lead parts 22, and terminal parts 23 (hereinafter, these are referred to collectively as electrode parts A) are formed inside the electrode concavity. Therefore, the pattern shape of the electrode concavity 20 is made slightly larger than the shape of the electrode parts A.

Transparent ITO (indium tin oxide) doped with tin oxide as an impurity is used as the material of the electrode parts A provided to the electrode concavity 20, and is formed by sputtering to a thickness of, e.g., 0.1 μm.

Therefore, the gap G between the vibration plate 12 and the individual electrodes 21 is determined by the depth of the electrode concavity 20 and the thickness of the individual electrodes 21. The gap G greatly affects the discharge characteristics.

Here, the material of the electrode parts A is not limited to ITO, and chromium or another metal may be used as the material, but in the illustrated embodiment, transparent ITO is used in order to facilitate confirmation of electric discharge.

A fluid feedhole (first fluid feedhole part) 24 is formed in the electrode substrate 2 by sand blasting or cutting. The feedhole is formed completely through the outer-side substrate of the electrode parts A in the vertical direction (the laminating direction) in communication with the fluid feedhole 17 of the cavity substrate 1.

A vapor-phase processing line 25 is a groove for carrying out a dewatering process and a hydrophobic treatment in the gap G formed after the electrode substrate 2 has been bonded to the cavity substrate 1.

The nozzle substrate 3 is arranged on the upper side (upper side of FIG. 1) of the cavity substrate 1, and includes a first nozzle base element 4 (first substrate layer) positioned on the fluid discharge side and a second nozzle base element 5 (second substrate layer) positioned on the fluid introduction side. The first nozzle base element 4 is made of silicon material and has a thickness of about 150 μm. The second nozzle base element 5 is made of borosilicate glass material and has a thickness of about 30 μm. The first and second nozzle base elements 4, 5 are bonded together by anodic bonding (bonding surface b) to constitute the nozzle substrate 3, and the second nozzle base element 5 of the nozzle substrate 3 is bonded to the cavity substrate 1 by anodic bonding (bonding surface c).

Nozzle holes 30 are provided in a nozzle concave surface 34 of the nozzle substrate 3, and first nozzle holes 31, as the nozzle parts on the fluid discharge side (the fluid discharge nozzle parts), are formed in the first nozzle base element 4. Second nozzle holes 32, as the nozzle parts on the fluid introduction side (the fluid introduction nozzle parts) that is in communication with the first nozzle holes 31 and the discharge chambers 13, have a greater diameter than the first nozzle holes 31 and are coaxially formed in the second nozzle base element 5. Formed in the second nozzle base element 5 are an orifice 33 that is in communication with the reservoir 14 (reservoir recess portion 14a) and the discharge chambers 13 of the cavity substrate 1, and a second reservoir recess portion 14b that is in communication with the reservoir recess portion 14a and the fluid feed groove 17a is formed.

The second reservoir recess portion 14b opens toward the reservoir recess portion 14a of the cavity substrate 1, and the reservoir 14 is formed by the reservoir recess portion 14a and the second reservoir recess portion 14b. Fluid fed from the fluid feedholes 24, 17 is transferred from the fluid feed groove 17a to the reservoir recess portion 14a via the second reservoir recess portion 14b. In this manner, fluid is transferred from the fluid feed groove 17a to the reservoir recess portion 14a via the second reservoir recess portion 14b, the volume of the reservoir 14 is increased, and the channel resistance of the reservoir 14 is reduced.

An actuator including the vibration plate 12 and the individual electrodes 21 is sealed in each individual electrode 21 using a sealing material 50 in the droplet discharge head. Therefore, sticking or the like of the individual electrodes 21 and the vibration plate 12 can be prevented when the actuator is driven.

The terminal parts 23 of the electrode parts A formed on the electrode substrate 2 are connected to an oscillation circuit 40 together with the terminal part 18 of the shared electrode formed on the cavity substrate 1.

The operation of the droplet discharge head configured in the manner described above will be described.

Discharge fluid to be discharged from the nozzle holes 30 is stored in the discharge chambers 13, as shown in FIG. 2. The vibration plate 12, which is the bottom wall of the discharge chambers 13, is flexed, the pressure in the discharge chambers 13 is increased, and droplets are discharged from the nozzle holes 30.

In this situation, the oscillation circuit 40 controls the feeding and stoppage of an electric charge to the individual electrodes 21. For example, oscillation is set to 24 kHz, and an electric charge is fed by applying a pulse potential of 0 V and 30 V to the individual electrodes 21.

When the electric load is fed and the individual electrodes 21 are positively electrified, the vibration plate 12 is negatively electrified and drawn toward to the individual electrodes 21 and made to flex due to the electrostatic force. The volume of the discharge chambers 13 is thereby increased. The vibration plate 12 returns to its original state when the electric load supplied to the individual electrodes 21 is stopped, but the volume of the discharge chambers 13 at that time also returns to its original state and rapidly decreases. Therefore, a droplet commensurate with the pressure difference is discharged and made to land on recording paper, which is the recording target in the case of ink droplets, for example, whereby recording is carried out.

The nozzle substrate 3 according to the present invention has excellent compatibility with fluid because it is bonded by anodically bonding the first nozzle base element 4 made of silicon material and the second nozzle base element 5 made of borosilicate material without the use of an adhesive. The first nozzle holes 31 on the fluid discharge side are formed in the first nozzle base element 4, the second nozzle holes 32 on the fluid introduction side, which have a greater diameter than the first nozzle holes 31 on the fluid discharge side, are formed in the second nozzle base element 5, and the nozzle holes 30 are formed when the nozzle base elements 4, 5 are bonded together. Therefore, very small, highly precise nozzle holes 30 can be manufactured in a simple manner. In this case, machinability is excellent because the first nozzle base element 4 on the fluid discharge side is formed using a silicon material.

The droplet discharge head according to the present invention has excellent fluid compatibility, can withstand long-term driving, and has high precision and reliability because the cavity substrate 1 is formed using a silicon material, the electrode substrate 2 is formed using a borosilicate glass material, the nozzle substrate 3 is formed by anodically bonding the base element 4 made of silicon material and the base element 5 made of borosilicate material, the cavity substrate 1 and the electrode substrate 2 are anodically bonded, and the bonding does not use an adhesive.

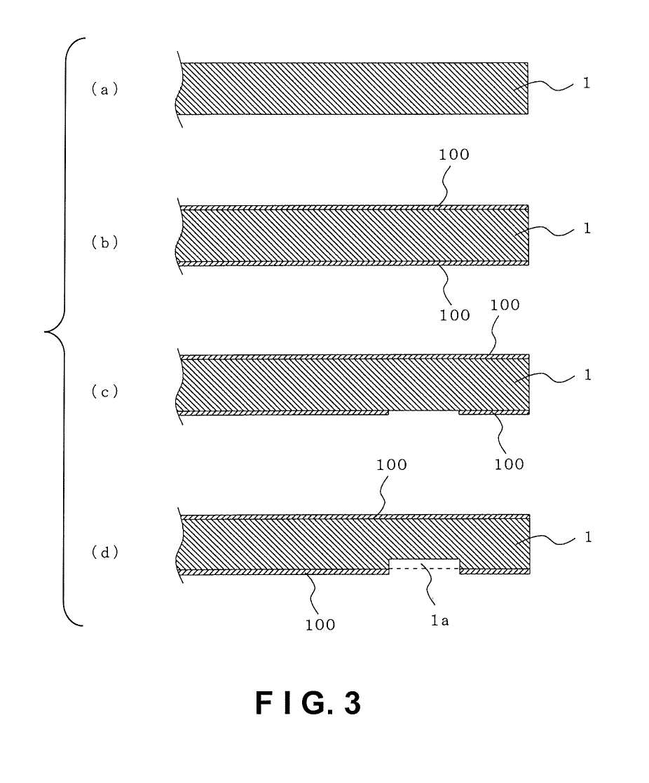

The method for manufacturing the droplet discharge head configured in the manner described above will be described with reference to FIGS. 3 through 14.

The numerical values provided in the description below are examples, and no limitation is imposed thereby.

FIGS. 3 to 5 are views of manufacturing steps showing the method for manufacturing the cavity substrate 1 prior to anodic boding with the electrode substrate 2.

(a) One side of the cavity substrate 1, which is made of silicon material having a low oxygen concentration and an orientation of (110), is mirror polished to produce a substrate having a thickness of, e.g., 220 μm (FIG. 3(a)).

(b) A SiO₂ film 100 having a thickness of about 1.2 μm is formed on the two sides of the cavity substrate 1 by oxidation for 4 hours at 1,075° C., for example, in an oxygen and water vapor atmosphere (FIG. 3(b)).

(c) A resist is applied to the two sides of the cavity substrate 1, a resist pattern for forming the groove 1a on the reverse side of the reservoir is applied (see FIG. 3(d)), and etching is carried out using an aqueous solution of hydrofluoric acid to pattern the SiO₂ film 100 (FIG. 3(c)). The resist is then peeled away.

(d) The cavity substrate 1 is immersed in an aqueous solution of potassium hydroxide having a concentration of 35 wt %, and etching is carried out until the depth of the groove 1a on the reverse side of the reservoir reaches about 5 μm (FIG. 3(d)).

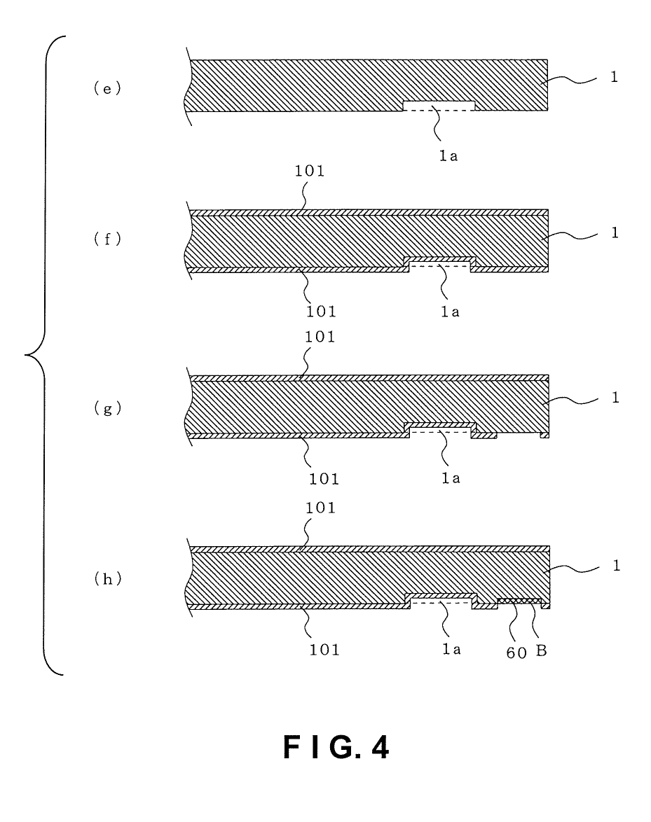

(e) The cavity substrate 1 is immersed in an aqueous solution of hydrofluoric acid, and the SiO₂ film 100 is removed from both sides (FIG. 4(e)).

(f) A SiO₂ film 101 having a thickness of about 2.0 μm is formed on the two sides of the cavity substrate 1 by oxidation for 12 hours at 1,075° C., for example, in an oxygen and water vapor atmosphere (FIG. 4(f)).

(g) A resist is applied to the two sides of the cavity substrate 1, a resist pattern for forming a selective diffusion part 60 is applied (see FIG. 4(h)), and etching is carried out using an aqueous solution of hydrofluoric acid to pattern the SiO₂ film 101 (FIG. 4(g)). The resist is then peeled away.

(h) The surface of the cavity substrate 1 on the side on which the boron-doped layer is formed is placed opposite a solid diffusion source having B₂O₃ as a principal component and is set in a quartz boat. The quartz boat is set in a vertical oven, a nitrogen atmosphere is set inside the oven, the temperature is increased to, e.g., 1,100° C. and held for, e.g., six hours, boron is diffused in the cavity substrate 1, and the boron-doped layer B is formed in the selective diffusion part 60 (FIG. 3(h)). In the boron-doping step, the temperature at which the cavity substrate 1 is introduced is set to, e.g., 800° C., and the temperature at which the cavity substrate 1 is removed is set to 800° C. Since it is thereby possible to rapidly transport the substrate through the region (600° C. to 800° C.) in which the growth speed of oxygen defects is high, the occurrence of oxygen defects can be suppressed.

In this case, the SiO₂ film 101 acts as a mask, and boron is not diffused because the SiO₂ film 101 remains on portions other than the selective diffusion part 60 and on the surface on the side opposite of the diffusion surface.

(i) A boron compound SiB₆ is formed (not shown) on the surface of the boron-doped layer B and is chemically changed to B₂O₃+SiO₂, which can be etched using an aqueous solution of hydrofluoric acid, by oxidation for 90 minutes at 600° C., for example, in an oxygen and water vapor atmosphere.

A resist is applied to the surface on the side opposite of the selectively diffused surface, and the cavity substrate 1 is immersed for, e.g., 10 minutes in an aqueous solution of hydrofluoric acid. In this manner, the B₂O₃+SiO₂ film of the selective diffusion part 60 and the SiO₂ film 101 of the diffusion surface are removed by etching (FIG. 3(i)). The resist is then peeled away.

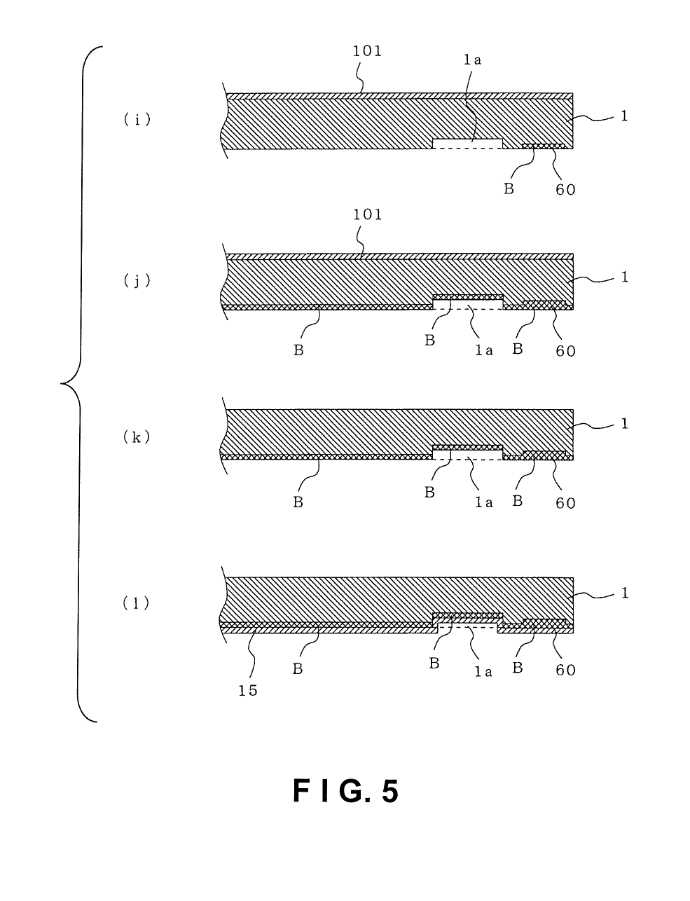

(j) In the same manner as step (h), the surface of the cavity substrate 1 on the side on which the boron-doped layer is formed is placed opposite a solid diffusion source having B₂O₃ as a principal component and is set in a quartz boat. The quartz boat is set in a vertical oven, a nitrogen atmosphere is set inside the oven, the temperature is increased to, e.g., 1,050° C. and held for, e.g., seven hours, boron is diffused in the cavity substrate 1, and the boron-doped layer B is formed over the entire surface of the diffusion surface (see FIG. 5(j)). In the boron-doping step, the temperature at which the cavity substrate 1 is introduced is set to, e.g., 800° C., and the temperature at which the cavity substrate 1 is removed is set to 800° C. Since it is thereby possible to rapidly transport the substrate through the region (600° C. to 800° C.) in which the growth speed of oxygen defects is high, the occurrence of oxygen defects can be suppressed.

In this case, the SiO₂ film 101 acts as a mask, and boron is not diffused even when boron has migrated around to the opposite surface, because the SiO₂ film 101 remains on the surface on the side opposite of the diffusion surface.

The boron concentration of the selective diffusion part 60 selectively diffused in advance is greater than other portions, and boron is also diffused further inside the cavity substrate 1 (FIG. 5(j)).

(k) Similar to step (i), a boron compound SiB₆ is formed (not shown) on the surface of the boron-doped layer B and is chemically changed to B₂O₃+SiO₂, which can be etched using an aqueous solution of hydrofluoric acid, by oxidation for 90 minutes at 600° C., for example, in an oxygen and water vapor atmosphere. The cavity substrate 1 is immersed for, e.g., 10 minutes in an aqueous solution of hydrofluoric acid. In this manner, the B₂O₃₊SiO₂ film on the diffusion surface and the SiO₂ film 101 on the opposite surface are removed by etching (FIG. 5(k)).

(l) A TEOS insulating film 15 is formed to a thickness of 0.1 μm using plasma CVD on the surface on which the boron-doped layer B has been formed, in conditions in which, e.g., the processing temperature during film formation is 360° C., the high-frequency output is 250 W, the pressure is 66.7 Pa (0.5 torr), and the gas flow rates are 100 cm³/min (100 sccm) for TEOS and 1000 cm³/min (1000 sccm) for oxygen (FIG. 5(l)).

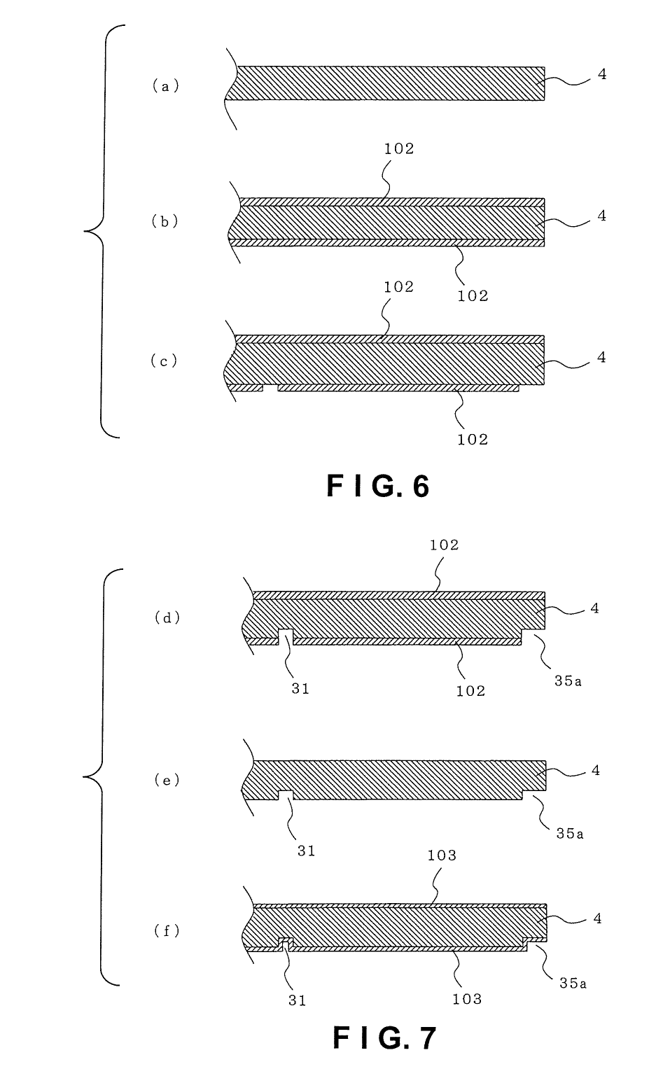

FIGS. 6 to 10 are views of the manufacturing steps that show the method for manufacturing the nozzle substrate 3.

(a) One side of the first nozzle base element 4, which is made of silicon material having an orientation of (100), is mirror polished to a thickness of, e.g., 150 μm (FIG. 6(a)).

(b) A SiO₂ film 102 having a thickness of about 1.8 μm is formed on the two sides of the first nozzle base element 4 by oxidation for eight hours at 1,075° C., for example, in an oxygen and water vapor atmosphere (FIG. 6(b)).

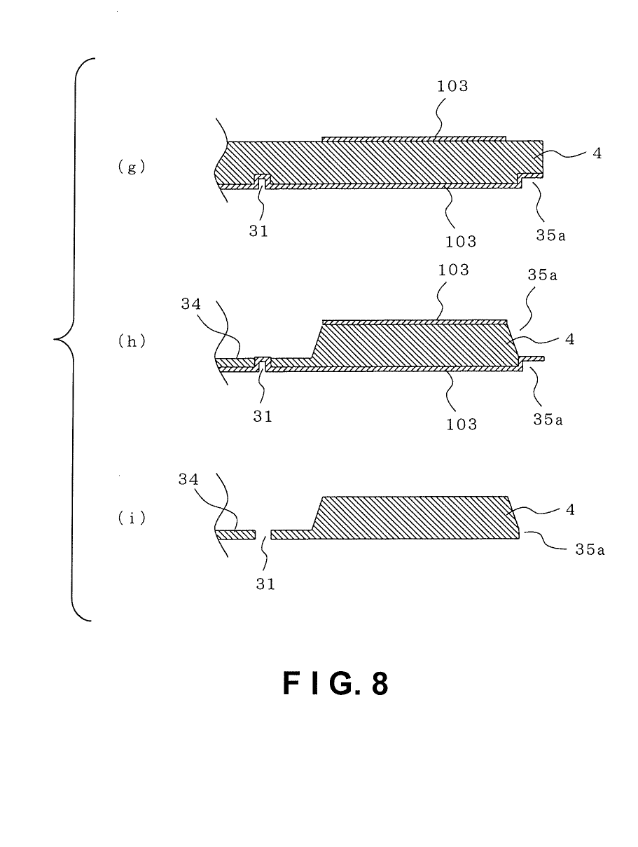

(c) A resist is applied to the two sides of the first nozzle base element 4, a resist pattern for forming the first nozzle holes 31 in the mirror surface and the upper electrode lead-out part 35a is applied (see FIG. 8(i)), and etching is carried out using an aqueous solution of hydrofluoric acid to pattern the SiO₂ film 102. The resist is then peeled away (FIG. 6(c)).

(d) The first nozzle holes 31 and the upper electrode lead-out part 35a are etched to a depth of about 20 μm using an ICP dry etching device (FIG. 7(d)). The etching conditions are, e.g., an SF₆ flow rate of 400 cm²/min (400 sccm), an etching time 3.5 seconds, a chamber pressure of 8 Pa, a coil power 2200 W, a platen power 55 W, and a platen temperature of 20° C. in the etching process, and a C₄F₆ flow rate of 200 cm³/min (200 sccm), an etching time 2.5 seconds, a chamber pressure of 2.7 Pa, a coil power 1800 W, and a platen temperature of 20° C. in the deposition process. The etching process and the deposition process combine to form a single cycle, and about 50 cycles are carried out.

(e) The first nozzle base element 4 is immersed in an aqueous solution of hydrofluoric acid, and the SiO₂ film 102 remaining on the two sides of the cavity substrate 1 is peeled away (FIG. 7(e)).

(f) A SiO₂ film 103 having a thickness of about 1.2 μm is formed on the two sides of the first nozzle base element 4 by oxidation for 4 hours at 1,075° C., for example, in an oxygen and water vapor atmosphere (FIG. 7(f)).

(g) A resist is applied to the two sides of the first nozzle base element 4, a resist pattern for forming an upper electrode lead-out part 35a and a nozzle concave surface 34 on the opposite side of the mirror surface is applied (see FIG. 8(i)), and etching is carried out using an aqueous solution of hydrofluoric acid to pattern the SiO₂ film 103. The resist is then peeled away (FIG. 8(g)).

(h) The first nozzle base element 4 is immersed in an aqueous solution of potassium hydroxide having a concentration of 25 wt %, for example, and etching is carried out until the depth of the nozzle concave surface 34 and the upper electrode lead-out part 35a reaches about 130 μm (FIG. 8(h)).

(i) The first nozzle base element 4 is immersed in an aqueous solution of hydrofluoric acid, and the SiO₂ film 103 remaining on the two surfaces of the first nozzle base element 4 is peeled away. The first nozzle holes 31 are thereby formed completely through the first nozzle base element 4, and an upper electrode lead-out part 35a is opened in the first nozzle base element 4 (FIG. 8(i)).

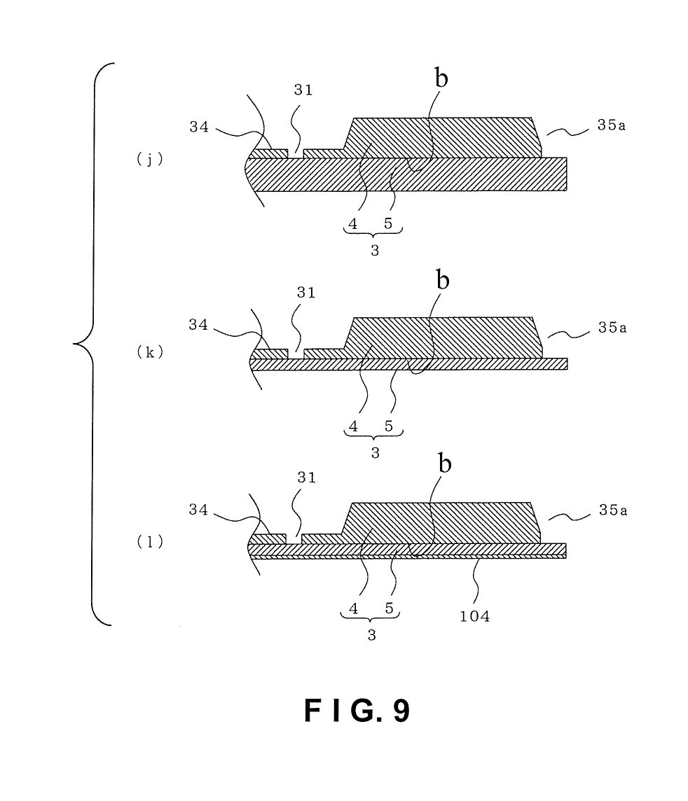

(j) There is a second nozzle base element 5 made of glass material having a thickness of, e.g., 500 μm in which one surface of the borosilicate heat-resistant hard glass has been mirror polished. The first nozzle base element 4 made of silicon material machined in steps 6 to 8, and the unmachined second nozzle base element 5 made of glass material, are heated to, e.g., 360° C. The negative pole is connected to the second nozzle base element 5, and the positive pole is connected to the first nozzle base element 4. A voltage of, e.g., 800 V is applied and the first nozzle base element 4 and the second nozzle base element 5 are anodically bonded together (bonding surface c) (FIG. 9(j)).

(k) The second nozzle base element 5 is ground and polished to a thickness of about 30 μm (FIG. 9 (k)).

(l) A Cr/Au film 104 (The Cr film on the second nozzle base element 5 side) is formed by sputtering (FIG. 9 (l)) on the surface of the second nozzle base element 5 on the side opposite of the first nozzle base element 4 (FIG. 9 (l)).

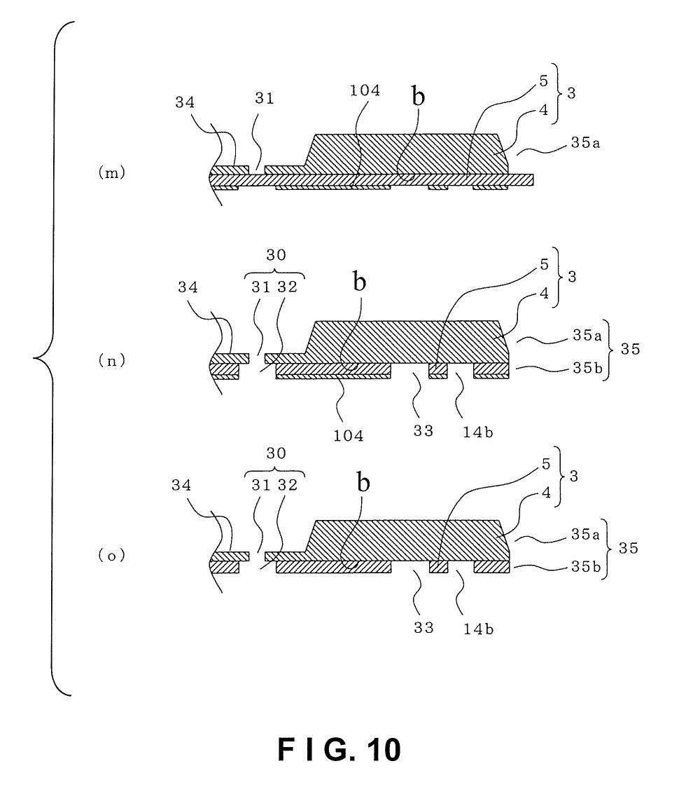

(m) A resist is applied to the Cr/Au film 104, and a resist pattern for forming the second nozzle holes 32, the orifice 33, the second reservoir recess portion 14b, and an upper electrode lead-out part 35b is applied (see FIG. 10(n)). The Au film is etched using an aqueous solution of iodine-potassium iodide, and the Cr film is subsequently etched using an aqueous solution of diammonium cerium nitrate (FIG. 10 (m)).

(n) The second nozzle base element 5 is etched using an aqueous solution of hydrofluoric acid. The second nozzle holes 32, the orifice 33, the second reservoir recess portion 14b, and the upper electrode lead-out part 35b are formed thereby, the first nozzle holes 31 and the second nozzle holes 32 are placed in communication to form the nozzle holes 30, and the terminal parts 35 (35a, 35b) on the side on which the electrodes are brought out are opened (FIG. 10(n)).

(o) The resist, the Au film, and the Cr film are each peeled away (FIG. 10 (o)).

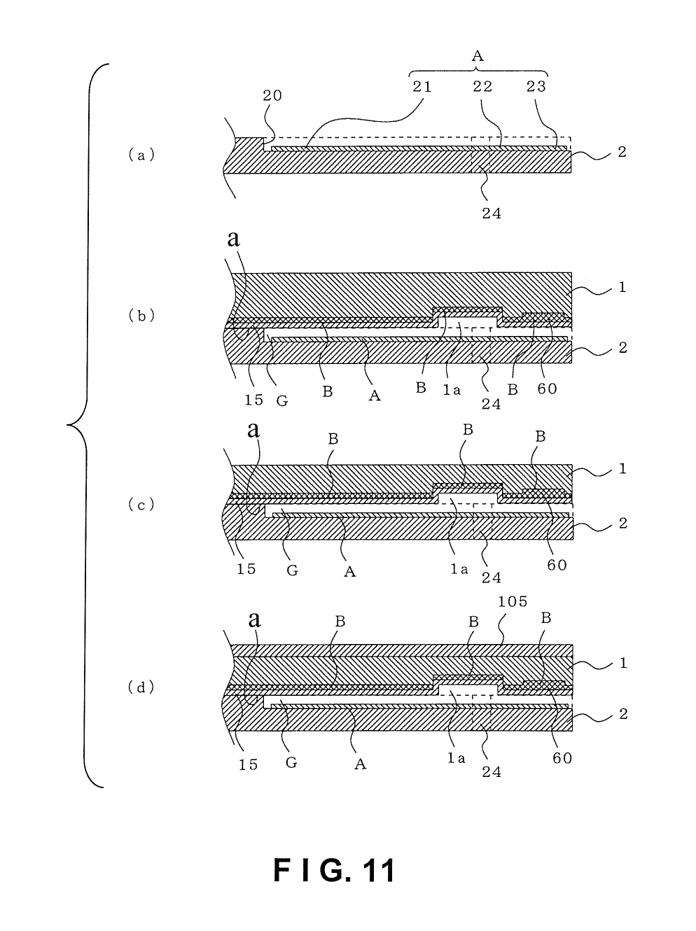

FIGS. 11 to 14 are views of the manufacturing steps showing the method for layering the electrode substrate 2, the cavity substrate 1, and the nozzle substrate 3 to produce a droplet discharge head.

In actual practice, the members of several droplet discharge heads are simultaneously formed from a substrate, but only a portion thereof is shown in FIGS. 11 to 14.

(a) The electrode substrate 2 made of glass material is formed, and formed therein are the individual electrodes 21, the lead parts 22, the terminal parts 23, the vapor-phase processing line 25 (see FIG. 1), and the fluid feedhole 24 (FIG. 11 (a)).

(b) The cavity substrate 1 made of silicon material and manufactured using the manufacturing method of FIGS. 3 to 5, and the electrode substrate 2 made of glass material are heated to, e.g., 360° C. The negative pole is then connected to the electrode substrate 2, and the positive pole is connected to the cavity substrate 1. A voltage of 800 V is applied to carry out anodic bonding (bonding surface a) (FIG. 11(b)).

(c) After anodic bonding, the cavity substrate 1 is ground to a thickness of about 60 μm. About 10 μm of the cavity substrate 1 is thereafter polished away by chemical machine polishing (CMP) to remove the machine-altered layer (FIG. 11(c)). The thickness of the cavity substrate 1 is thereby brought to about 50 μm.

(d) A TEOS etching mask 105 is formed to a thickness of 1.0 μm using plasma CVD on the polished surface in conditions in which, e.g., the processing temperature during film formation is 360° C., the high-frequency output is 700 W, the pressure is 33.3 Pa (0.25 torr), and the gas flow rates are 100 cm³/min (100 sccm) for TEOS and 1000 cm³/min (1000 sccm) for oxygen (FIG. 11(d)).

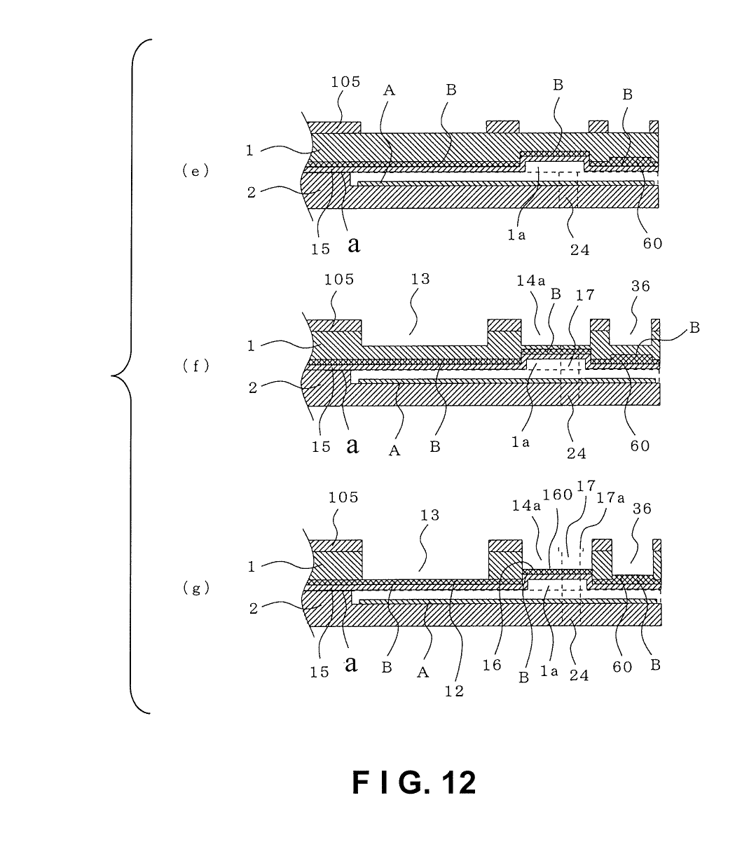

(e) A resist pattern is formed on the TEOS etching mask 105, etching is carried out using an aqueous solution of hydrofluoric acid to form patterns for the discharge chambers 13, the reservoir recess portion 14a (reservoir 14), the upper electrode lead-out part 36, and the fluid feed groove 17a (see FIG. 12 (g)). The resist is then peeled away (FIG. 11(e)).

(f) The bonded substrate is immersed in an aqueous solution of potassium hydroxide having a concentration of 35 wt %, and etching is carried out until the thickness of the discharge chambers 13 and the upper electrode lead-out part 36 reaches about 10 μm. The reservoir recess portion 14a has a groove 1a on the reverse surface, and therefore has a thickness of about 5 μm. However, the concentration of the aqueous solution of potassium hydroxide is high in the fluid feed groove 17a, which corresponds to the fluid feedhole 24 provided in the electrode substrate 2. Therefore, etching progresses from the bonding surface side even though the etching rate in the boron-doped layer B is reduced (FIG. 12(f)).

(g) The bonded substrate is immersed in an aqueous solution of potassium hydroxide having a concentration of 3 wt %, and etching is continued until the etching stop takes sufficient effect due to the reduced etching rate on the boron-doped layer B. Etching that uses two different types of concentration of the aqueous solution of potassium hydroxide is carried out, whereby the surface roughness of the vibration plate 12 can be reduced, the thickness precision of the vibration plate 12 can be kept to 0.80 ±0.05 μm or less, and the discharge characteristics of the droplet discharge head can be stabilized. A diaphragm 16 in which the boron-doped layer B having a thickness of 0.8 μm is used as the bottom wall is formed in the same manner as the vibration plate 12 on the bottom of the reservoir recess portion 14a as well (FIG. 12 (g)).

In the selectively diffused upper electrode lead-out part 36, the etching stop begins to have effect sooner in comparison with the boron-doped layer B on the side of the vibration plate 12, and the thickness of the upper electrode lead-out part 36 reaches about 3 μm because of the formation of the deep, high-concentration boron-doped layer B. Accordingly, strength is improved, the breakage of the upper electrode lead-out part 36 having a large surface area during silicon etching is eliminated, and yield is improved.

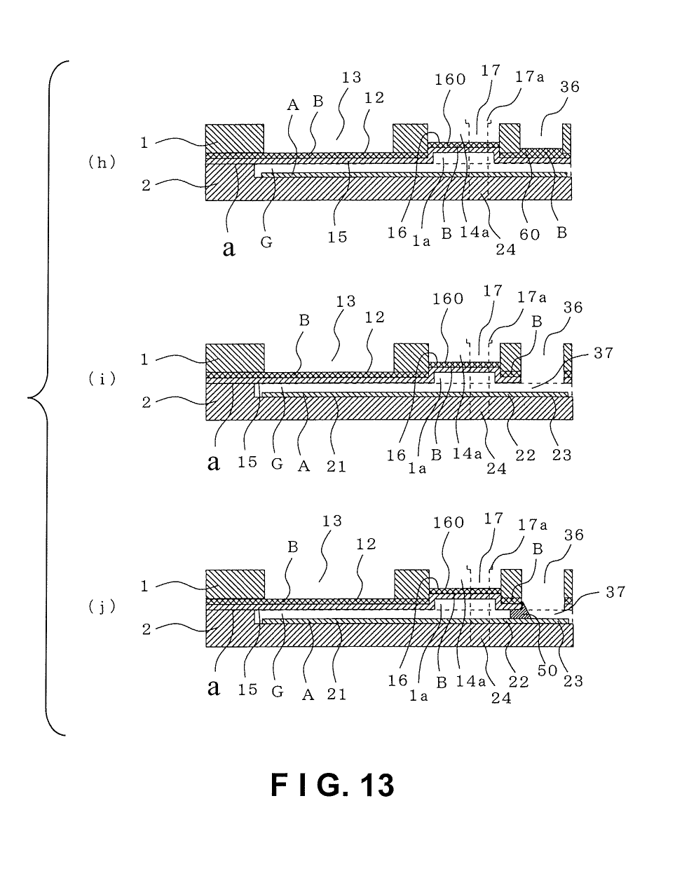

(h) When silicon etching has ended, the bonded substrate is immersed in an aqueous solution of hydrofluoric acid, and the TEOS etching mask 105 on the surface of the cavity substrate 1 is peeled away (FIG. 13(h)).

(i) A silicon mask is affixed to the surface of the cavity substrate 1 in order to remove the silicon film and the TEOS insulating film remaining on the upper electrode lead-out part 36, and RIE dry etching is carried out for, e.g., one hour using conditions in which, e.g., the RF power is 200 W, the pressure is 40 Pa (0.3 ton), and the CF₄ flow rate is 30 cm³/min (30 sccm). Only desired locations are exposed to plasma, an opening is formed, and the upper electrode lead-out part 36 is opened. An electrode lead-out part 37 is opened through an opening in the upper electrode lead-out part 36. At this point, the gap G is exposed to atmosphere (FIG. 13 (i)).

(j) An epoxy resin is applied to the sealing part, and the sealing material 50 is used for sealing each individual electrode 21. TEOS film or another inorganic material may be used to seal the epoxy resin in place. The gap G is not sealed at this point. The moisture inside the gap G is removed and a hydrophobic treatment is carried out via the end part of the vapor-phase processing line 25 (see FIG. 1), after which the epoxy resin is applied to the end part of the vapor-phase processing line 25 and the gap G is sealed (FIG. 13 (j)).

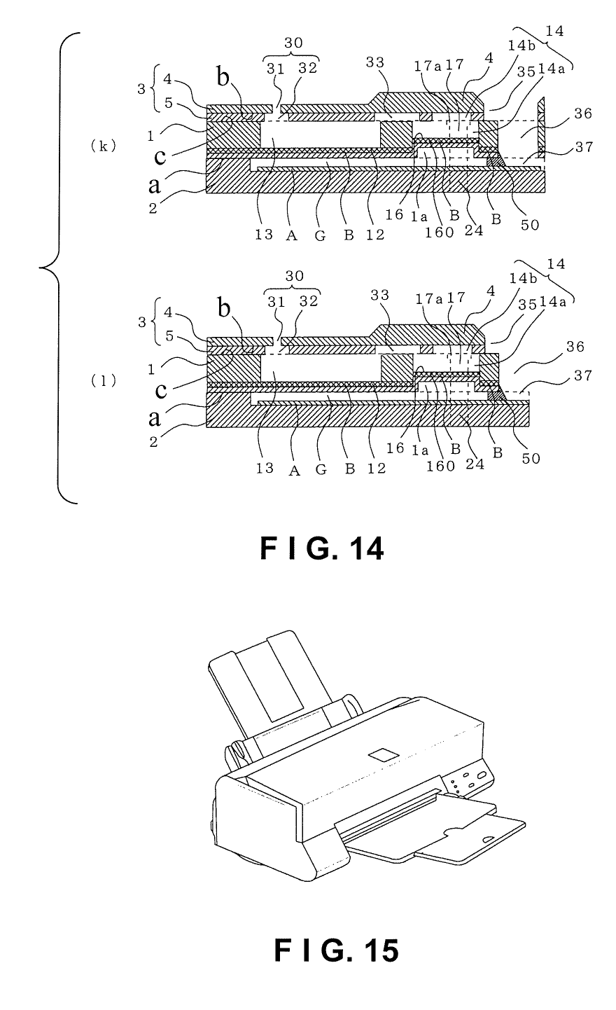

(k) The nozzle substrate 3 fabricated using the manufacturing method of FIGS. 6 to 10 is anodically bonded (bonding surface c) to the cavity substrate 1 (FIG. 14 (k)).

(l) Dicing is carried out to cut the heads into individual units (FIG. 14 (l)).

In this manner, a droplet discharge head in which the electrode substrate 2, the cavity substrate 1, and the nozzle substrate 3 are layered is completed.

### Droplet Discharge Device

FIG. 15 is a perspective view showing a droplet discharge device in which the droplet discharge head according to the illustrated embodiment has been mounted. The droplet discharge device shown in FIG. 15 is a common inkjet printer.

The droplet discharge head of the illustrated embodiment is formed without the use of an adhesive because the substrates are bonded together using only anodic bonding. Therefore, fluid compatibility is excellent and the droplet discharge head can withstand long-term driving. Accordingly, a droplet discharge device having high precision and high reliability can be obtained.

The droplet discharge head of the illustrated embodiment can be applied to the inkjet printer shown in FIG. 15, and, by using various types of fluid, can also be used in the manufacture of a color filter of a liquid crystal display, the formation of a luminescent portion of an organic EL display device, the discharge of a bio-fluid, as well as other applications.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A nozzle substrate having a nozzle hole for discharging droplets, the nozzle substrate comprising:
a first substrate layer disposed on a fluid discharge side of the nozzle substrate, the first substrate layer being made of silicon material; and
a second substrate layer disposed on a fluid introduction side of the nozzle substrate, the second substrate layer being made of borosilicate glass material.

2. The nozzle substrate according to claim 1, wherein
the first substrate layer and the second substrate layer are anodically bonded.

3. The nozzle substrate according to claim 1, wherein
the first substrate layer includes a fluid discharge nozzle part of the nozzle hole, and
the second substrate layer includes a fluid introduction nozzle part of the nozzle hole with the fluid introduction nozzle part having a larger diameter than the fluid discharge nozzle part and being coaxial to the fluid discharge nozzle part.

4. A droplet discharge head comprising:
the nozzle substrate according to claim 1;
a cavity substrate having a discharge chamber and a reservoir recess portion, the discharge chamber fluidly communicating with the nozzle hole with a vibration plate being formed in a portion of a wall surface of the discharge chamber, the reservoir recess portion being arranged to feed fluid to the discharge chamber; and
an electrode substrate having an individual electrode disposed to face the vibration plate so that the vibration plate is displaced by electrostatic force between the vibration plate and the individual electrode to discharge fluid in the discharge chamber from the nozzle hole,
the cavity substrate and the nozzle substrate being anodically bonded, and the cavity substrate and the electrode substrate being anodically bonded.

5. The droplet discharge head according claim 4, wherein
the cavity substrate is made of silicon material and the electrode substrate is made of borosilicate glass substrate,
the first and second substrate layers of the nozzle substrate are anodically bonded, and
the second substrate layer of the nozzle substrate and the cavity substrate are anodically bonded.

6. The droplet discharge head according to claim 5, wherein
a bottom part of the reservoir recess portion of the cavity substrate is disposed closer to the nozzle substrate than a bottom part of the discharge chamber to form a diaphragm.

7. The droplet discharge head according claim 6, wherein
the bottom part of the reservoir recess portion includes a bottom wall having a boron-doped layer to form a pressure interference diaphragm.

8. The droplet discharge head according to claim 4, wherein
the second substrate layer of the nozzle substrate includes a second reservoir recess portion fluidly communicating with the reservoir recess portion of the cavity substrate so that the second reservoir recess portion and the reservoir recess portion form a reservoir.

9. The droplet discharge head according to claim 4, wherein
the electrode substrate includes a first fluid feedhole part,
the cavity substrate includes a second fluid feedhole part fluidly communicating with the first fluid feedhole part to form a fluid feedhole adjacent to the reservoir with the fluid feedhole penetrating through the electrode substrate and the cavity substrate in a laminating direction of the electrode substrate and the cavity substrate,
the second fluid feedhole part has a droplet feed groove that widens at a downstream side of the second fluid feedhole part so that fluid fed from the fluid feedhole is transferred from the fluid feed groove to the reservoir recess portion via the second reservoir recess portion.

10. A method for manufacturing a nozzle substrate comprising:
forming a fluid discharge nozzle part in a first substrate layer made of silicon material;
anodically bonding a second substrate layer made of borosilicate glass material to the first substrate layer; and
forming a fluid introduction nozzle part in the second substrate layer coaxially to the fluid discharge nozzle part so that the fluid discharge nozzle part and the fluid introduction nozzle part form a nozzle hole.

11. A droplet discharge head comprising:
a nozzle substrate including a nozzle hole for discharging droplets, the nozzle substrate having
a first substrate layer disposed on a fluid discharge side of the nozzle substrate, the first substrate layer being made of silicon material, and
a second substrate layer disposed on a fluid introduction side of the nozzle substrate, the second substrate layer being made of borosilicate glass material;
a cavity substrate having a discharge chamber and a reservoir recess portion, the discharge chamber fluidly communicating with the nozzle hole with a vibration plate being formed in a portion of a wall surface of the discharge chamber, the reservoir recess portion being arranged to feed fluid to the discharge chamber; and
an electrode substrate having an individual electrode disposed to face the vibration plate so that the vibration plate is displaced by electrostatic force between the vibration plate and the individual electrode to discharge fluid in the discharge chamber from the nozzle hole,
the cavity substrate and the nozzle substrate being anodically bonded, and the cavity substrate and the electrode substrate being anodically bonded.
